(19) United States
(12) Patent Application Publication
(10) Pub. No.: US 2004/0008985 A1
(43) Pub. Date: Jan. 15, 2004

(54) Approach for operator directed routing in conjunction with automatic path completion

(76) Inventors: Jean Dolbec, Ottawa (CA); Robert Gaudet, Ottawa (CA); Kirby Koster, Almonte (CA)

Correspondence Address: MARKS & CLERK, P.O. BOX 957, STATION B, OTTAWA, ON, K1P 5S7, CA

(21) Appl. No.: 10/603,691

(22) Filed: Jun. 26, 2003

Related U.S. Application Data
(60) Provisional application No. 60/391,405, filed on Jun. 26, 2002.

(51) Int. Cl. H04B 10/08

(52) U.S. Cl. 398/25

(57) ABSTRACT

The problem solved by this invention is the definition of a well defined approach for creating lightpaths that uses a combination of both operator directed routing and automatic routing and allows the operator to change, at any point during the creation of the lightpath, the wavelength for any segment of the path. The key advantage of this approach is that it allows the operator to customize the lightpath to suit special end-customer needs or special networking requirements. The operator can utilize automatic routing algorithms to provide recommended wavelength selections and routing then, in the same operation, manually reject and select different wavelengths for some or all of the wavelengths in the lightpath.

This application claims the benefit of U.S. Provisional Application No. 60/391,405 filed Jun. 26, 2002.

### FIELD OF THE INVENTION

This invention relates to management systems for telecommunications networks and more particularly to methods of creating and routing lightpaths in an optical communications network.

### BACKGROUND

Optical networks are essential in the ongoing development of high speed communications systems. An all-optical environment presents the potential for much higher bandwidth applications then possible by the conventional twisted pair systems. An optical communication network typically employs optical fibers between switching nodes where each fiber has the capability of simultaneously carrying multiple wavelength signals. When setting up an optical connection from a source to a destination across the network numerous factors need to be taken into consideration. These factors include but are not limited to speed and cost. Additionally, specific end users may have requirements that need to be factored and which may not relate to other inherent factors of the systems.

The ability to create end to end lightpaths through the network while accommodating the specific needs of its users is an essential feature of the design of NMS. Preferably the process of creating lightpaths should allow flexibility so that the above can be satisfied. Within an optical communication network the design of a network management system (NMS) is critical in the creation and routing of lightpaths within a network. Current approaches for creating lightpaths in a wavelength transparent mesh optical network or other types of network topologies such as synchronized optical network (SONET) are restricted in that:

1. Lightpaths are typically pre-defined according to rigid network-design constraints. The choices of paths and wavelengths are therefore limited. Once a path has been selected, the operator is unable to change the corresponding wavelengths defined for the path.

2. The path selection process is completely manual or completely automatic.

3. Operators cannot override the wavelengths selected through automatic routing.

Therefore, there is a need for systems and methods of creating and routing lightpaths in an optical communications network that provides an operator with the flexibility to tailor the lightpath to meet users' needs.

### SUMMARY OF THE INVENTION

The problem solved by this invention is the definition of a well defined approach for creating lightpaths that uses a combination of both operator directed routing and automatic routing and allows the operator to change, at any point during the creation of the lightpath, the wavelength for any segment of the path. The key advantage of this approach is that it allows the operator to customize the lightpath to suit special end-customer needs or special networking requirements.

The operator can utilize automatic routing algorithms to provide recommended wavelength selections and routing then, in the same operation, manually reject and select different wavelengths for some or all of the wavelengths in the lightpath.

Therefore in accordance with a first aspect of the present invention there is provided a method of creating a lightpath between a source and destination in an optical communication system comprising: selecting a lightpath parameter; selecting lightpath endpoints; and automatically completing the lightpath.

In accordance with a second aspect of the invention there is provided a network management system (NMS) for creating a lightpath between a source and a destination in an optical communication system, the NMS comprising: means for viewing and selecting lightpath parameters; means for viewing and selecting lightpath endpoints at the source and destination; and means for completing the lightpath through intermediate nodes.

### BRIEF DESCRIPTION OF THE DRAWINGS

The invention will now be described in greater detail with reference to the attached drawings;

FIG. 1 is a flow chart of the approach for creating a lightpath according to the present invention;

FIG. 2 is a snap shot of a possible user interface used for selecting lightpath parameters; and

FIG. 3 is a snap shot of a possible user interface used for selecting lightpath endpoints.

### DETAILED DESCRIPTION OF THE INVENTION

There currently is no defined flexible approach for helping operators to create lightpaths in a wavelength transparent meshed optical network. The shortcomings of the current approaches include:

1. Existing implementations do not allow operators to override recommended routing and wavelength choices by automatic routing algorithms. Makes custom engineering difficult.

2. ‘Manual-only’ routing choices can be difficult to make in mesh network configurations.

3. Insufficient flexibility to support special custom routing choices after determining the cheapest or shortest routes. ‘The shortest is not always the preferred routing.’

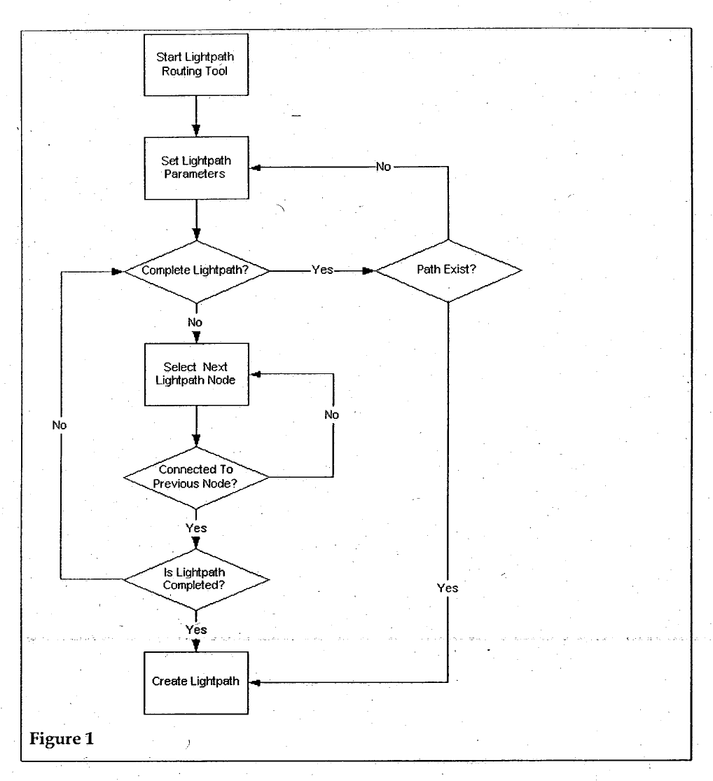

The framework combines the use of both operator directed routing and automatic routing using an algorithm. The automatic routing feature can be used at any point during the lightpath creation to complete the path. The automatic routing feature can, for each segment of the path, restrict the wavelength selection to a given range and support routing disjoint from other selected paths. The proposed approach for creating a light path is illustrated in the flowchart of FIG. 1. The approach can be broken down into three steps:

1. The selection of the lightpath parameters.

2. The selection of the lightpath end-points.

3. Automatic completion of the lightpath.

Step 1: Light Path Parameters Selection

This step involves the selection of the basic parameters associated with the lightpath. These are:

1. The lightpath name.

2. The lightpath protocol and bit rate.

3. The light path source node lambda end-point.

4. The light path destination node lambda end-point.

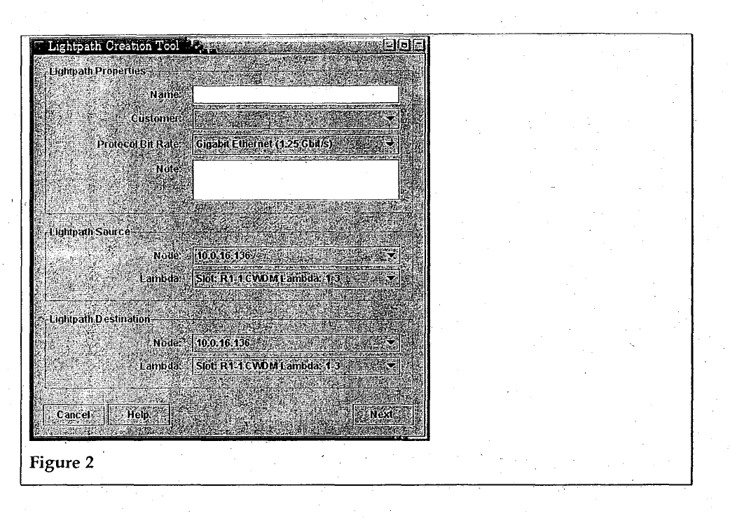

The selection of the source and destination lambdas is essential before proceeding to the next step. A snapshot of a possible user interface used for selecting the light path parameters is presented at FIG. 2.

Step 2: Light Path End-Points Selection

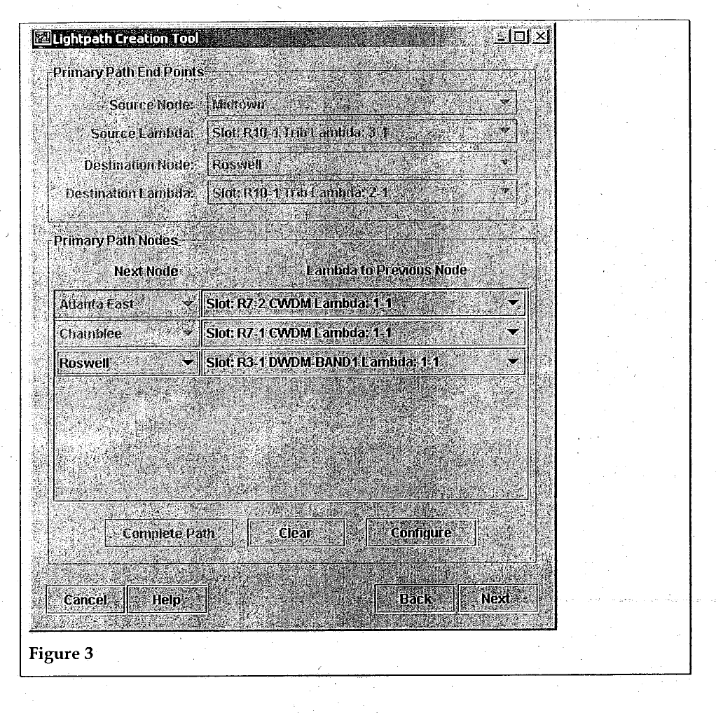

This step involves the selection of the nodes and corresponding wavelengths or lambdas that the lightpath will traverse. Visually the operator is presented with an interface resembling a two-column table. The first column shows the list of nodes that the operator has selected. Those are the nodes traversed by the lightpath. The second column has, for each node selection, the list of lambdas that lead to the previous node i.e. one row above starting with the source node selected at the first step. A snapshot of a possible user interface used for selecting the light path end-points is presented at FIG. 3.

The node selection process takes a “where do you want to go next” approach. By knowing the last node selected by the operator, it is possible to determine the set of nodes to which this node is connected thus limiting the list of potential choices for the operator. Similarly, once the user has selected a node, it is possible to narrow the choices of possible lambdas to only those present between this node and the previous one. When the operator selects the destination node as the next node, the operator is unable to select any more nodes and the light path can be created.

Step 3: Automatic Completion of the Lightpath

At any point during the selection process the operator can:

1. Ask to automatically complete the path.

2. Modify the choice of lambda used for any node selection.

The operator has two options to automatically complete a path. A default automatic completion will simply analyze the network and determine if connectivity exists between the source and destination nodes, regardless of the nature of the lambdas between these nodes. A variant of the automatic completion approach will allow the operator to restrict the selection of lambdas to a give wavelength range and/or to keep the path disjoint from a selection of already created paths. An algorithm is used to complete the path and, if a path exists, the list of nodes is automatically populated with the results.

Although specific embodiments of the present invention have been described and illustrated it will be apparent to one skilled in the art that numerous changes can be made without departing from the basic concept. It is to be understood, however, that such changes will fall within the full scope of the invention as defined by the appended claims.

1. A method of creating a lightpath between a source and a destination in an optical communications system a utilizing network management system (NMS) comprising:
selecting lightpath parameters;
selecting lightpath endpoints at the source and destination; and
completing the lightpath through intermediate nodes.

2. The method as defined in claim 1 wherein the lightpath is completed through intermediate nodes using an automatic selection algorithm.

3. The method as defined in claim 1 wherein the lightpath is completed through intermediate nodes using a manual selection process.

4. The method as defined in claim 1 wherein the lightpath is completed using a combination of an automatic selection algorithm and a manual selection process.

5. The method as defined in claim 1 wherein lightpath parameters include: lightpath name; protocol, bit rate, source node lambda end point and destination node lambda end-point.

6. The method as defined in claim 1 wherein the step of selecting endpoints include the selection of particular intermediate nodes that the lightpath will traverse.

7. The method as defined in claim 1 wherein the step of selecting endpoints includes the selection of wavelengths for the lightpath.

8. The method as defined in claim 7 wherein the selection of wavelengths is implementable at intermediate nodes.

9. The method as defined in claim 2 wherein after the lightpath has been selected automatically, an operator may reject and select different wavelengths for some or all of the wavelengths in the lightpath.

10. A network management system (NMS) for creating a lightpath between a source and a destination in an optical communication system, the NMS comprising:
means for viewing and selecting lightpath parameters;
means for viewing and selecting lightpath endpoints at the source and destination; and
means for completing the lightpath through intermediate nodes.

11. The NMS as defined in claim 10 having a graphical user interface (GUI) for displaying lightpath parameters and input means for selecting.

12. The NMS as defined in claim 11 wherein an operator can manually complete the lightpath.

13. The NMS as defined in claim 11 for implementing an automatic selection algorithm to automatically complete the lightpath.

14. The NMS as defined in claim 11 wherein the lightpath is completed utilizing manual selection and an automatic selection algorithm.

15. The NMS as defined in claim 13 wherein, after the lightpath has been selected automatically a user can change lightpath parameters.

16. The NMS as defined in claim 15 wherein lightpath parameters include wavelengths on a complete lightpath.

17. The NMS as defined in claim 15 wherein wavelengths can be changed for lightpath segments.
